(19) United States
(12) Patent Application Publication
(10) Pub. No.: US 2018/0061536 A1
(43) Pub. Date: Mar. 1, 2018

(54) CHIP RESISTOR

(71) Applicant: E I DU PONT DE NEMOURS AND COMPANY, Wilmington, DE (US)

(72) Inventor: YUSUKE TACHIBANA, KANAGAWA (JP)

(21) Appl. No.: 15/248,431

(22) Filed: Aug. 26, 2016

(51) Int. Cl. H01C 17/00; C09D 5/24; C04B 41/88; C04B 41/51; H01C 17/06; H01C 17/30

(52) U.S. Cl. CPC H01C 17/006; C09D 5/24; C04B 41/88; C04B 2111/94; H01C 17/06; H01C 17/30; C04B 41/5116

(57) ABSTRACT

The present invention relates to a chip resistor. A method of manufacturing a chip resistor comprising steps of: preparing an insulating substrate squarely segmented with vertical slits and horizontal slits, applying on the insulating substrate a conductive paste crossing over the horizontal slits, applying a resistor paste on the insulating substrate, forming trimming grooves to adjust resistivity of the resistor layers, and splitting the insulating substrate to form chip resistors, wherein the conductive paste comprises (i) a conductive powder comprising an agglomerated metal powder, wherein particle diameter (D50) of the agglomerated metal powder is 3 to 12 μm and specific surface area (SA) of the agglomerated metal powder is 3.1 to 8.0 m²/g, (ii) a glass frit and (iii) an organic vehicle.

### FIELD OF INVENTION

The present invention relates to a chip resistor, particularly to a conductive paste to form a chip resistor front electrode.

### TECHNICAL BACKGROUND OF THE INVENTION

Chip resistors are manufactured by using a large size substrate squarely segmented with slits. The substrate is divided into square chip resistors by splitting the substrate at the slits. More specifically, a conductive paste is applied crossing over the slits on the large substrate to form front electrodes followed by forming resistor layers. Resistivity of chip resistors are adjusted by, for example, laser trimming before splitting the substrate. Precise resistivity adjustment is bothered when the front electrodes are electrically connected to each other. A conductive paste needs to less spread out especially along the slits when applying on the substrate to form the front electrodes to be independent of one another.

JP2010287678 discloses a chip resistor. The front electrode of the chip resistor was formed by printing a conductive paste containing a metal powder, a Pb-free glass frit and a resin binder, wherein the metal powder is selected from a group consisting of gold (Au), silver (Ag), platinum (Pt), palladium (Pd) and alloy of those, and the glass frit contains a first glass frit containing 60 wt. % or more of SiO₂ and a second glass frit containing 5 wt. % or more of TiO₂, the weight ratio of the first glass frit and the second glass frit is 1:3 to 5:1.

### SUMMARY OF THE INVENTION

An objective is to provide a method of manufacturing a chip resistor where resistivity adjustment is properly made.

An aspect relates to a method of manufacturing a chip resistor comprising steps of: preparing an insulating substrate squarely segmented with vertical slits and horizontal slits; applying on the insulating substrate a conductive paste in a square pattern crossing over the horizontal slits; firing the conductive paste to form front electrodes; applying a resistor paste on the insulating substrate to bridge the front electrodes; firing the resistor paste to form resistor layers; forming trimming grooves on the resistor layers to adjust resistivity of the resistor layers; and splitting the insulating substrate at the vertical slits and the horizontal slits to form chip resistors; wherein the conductive paste comprises (i) a conductive powder comprising an agglomerated metal powder, wherein particle diameter (D50) of the agglomerated metal powder is 3 to 12 μm and specific surface area (SA) of the agglomerated metal powder is 3.1 to 8.0 m²/g, (ii) a glass frit and (iii) an organic vehicle.

Another aspect relates to a conductive paste comprising (i) a conductive powder comprising an agglomerated metal powder, wherein particle diameter of the agglomerated metal powder is 3 to 12 μm and specific surface area of the agglomerated metal powder is 3.1 to 8.0 m²/g, (ii) a glass frit and (iii) an organic vehicle.

### BRIEF DESCRIPTION OF THE DRAWINGS

FIGS. 1 to 5 are schematic diagrams of manufacturing method of a chip resistor.

FIG. 6 is a diagram explaining an agglomerated metal powder.

FIG. 7 shows a SEM picture of an agglomerated metal powder.

FIG. 8 shows a diagram explaining the measurement in Examples.

### DESCRIPTION OF THE PREFERRED EMBODIMENTS

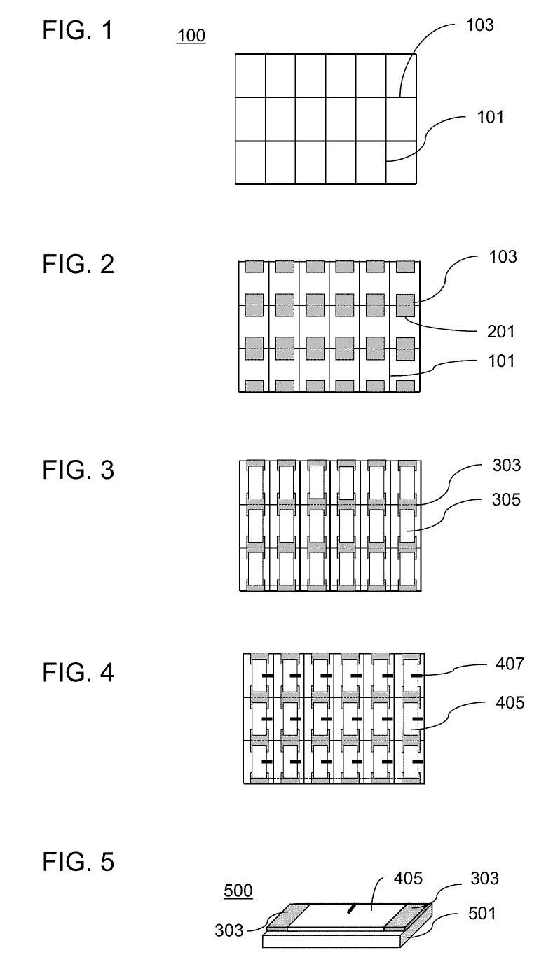

The method of forming a chip resistor is explained with FIGS. 1 to 5.

An insulating substrate 100 comprising vertical slits 101 and horizontal slits 103 is prepared (FIG. 1). The thickness of the insulating substrate 100 can be 0.1 to 2 mm in an embodiment, 0.2 to 1.5 mm in an embodiment, 0.3 to 1 mm in another embodiment. Cross section of the vertical slits 101 and horizontal slits 103 can be V-shaped in an embodiment. The vertical slits 101 and the horizontal slits 103 are 1 to 150 μm wide in an embodiment, 5 to 30 μm wide in another embodiment, 1 to 300 μm deep in an embodiment, 10 to 100 μm deep in another embodiment. The insulating substrate can be a ceramic substrate in an embodiment, an alumina substrate in another embodiment.

A conductive paste 201 is applied on the insulating substrate in a square pattern crossing over the horizontal slits 103 between the vertical slits 101 (FIG. 2). The conductive paste 201 is screen printed on the insulating substrate in an embodiment. The square pattern is 100 to 500 μm wide and 300 to 600 μm long and 1 to 20 μm thick in an embodiment. The conductive paste layer 201 are independent without bleeding or spreading along the horizontal slits 103 to connect to the adjacent conductive paste layer.

Front electrodes can be formed by firing the conductive paste layer 201. The firing peak temperature is 700 to 950° C. in an embodiment, 750 to 920° C. in another embodiment, 800 to 900° C. in another embodiment. Firing time at the peak temperature is 3 to 30 minutes in an embodiment, 5 to 20 minutes in another embodiment, 7 to 15 minutes in another embodiment.

Resistor paste 305 is applied on the insulating substrate to bridge the front electrodes 303 (FIG. 3). The both edges of the resistor paste layers 305 superposed on each end of the front electrodes (upper and lower) 303 in an embodiment. The resistor layer is formed by firing the resistor paste 305.

The firing peak temperature is 700 to 950° C. in an embodiment, 750 to 920° C. in another embodiment, 800 to 900° C. in another embodiment. Firing time at the peak temperature is 3 to 30 minutes in an embodiment, 5 to 20 minutes in another embodiment, 7 to 15 minutes in another embodiment.

Resistivity is adjusted by forming trimming grooves 407 on the resistor layers 405 (FIG. 4). The trimming grooves 407 are formed by laser on the resistor layer 405 in an embodiment. The trimming grooves 407 is single line, double lines or L-shape line in an embodiment. The laser is Yttrium-Aluminum-Garnet (YAG) laser (1064 nm), Greeb laser (532 nm) or UV laser (360 nm) in an embodiment. A laser trimmer, for example, LSR436 series from OMRON LASERFRONT INC. is available.

A chip resistor 500 is formed by splitting the insulating substrate at the vertical slits and horizontal slits (FIG. 5). A chip resistor 500 comprises an insulating substrate 501, a pair of front electrodes 303 and one resistor layer 405 formed on the insulating substrate 501.

Terminal electrodes can be further formed on both sides of the chip resistor 500 so as to electrically contact with the front electrodes 303 in an embodiment. The terminal electrodes can be formed by dipping the both sides of the chip resistor 500 into a conductive slurry containing at least a metal powder and an organic medium in an embodiment. The conductive slurry applied on both sides of the chip resister is heated. The heating temperature is 150 to 300° C. when the conductive slurry is heat-curable type in an embodiment. The heating temperature is 700 to 950° C. when the conductive slurry is firing type in another embodiment.

A coating layer can be further formed over the front electrodes and the resistor layer in an embodiment. The coating layer is a resin layer or a glass layer in an embodiment.

The conductive paste to form the front electrodes comprises a conductive powder comprising aggregates of metal particles, a glass frit, and an organic vehicle.

### Conductive Powder

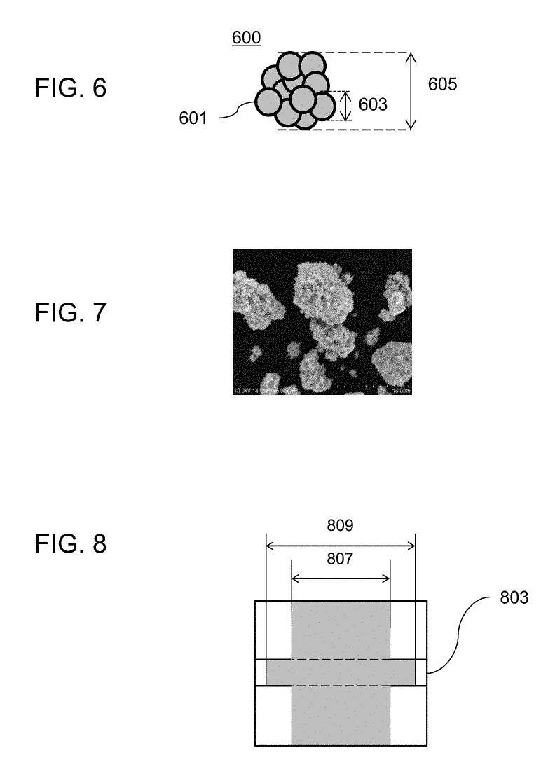

The conductive powder comprises an agglomerated metal powder. Agglomerated metal powder 600 is a cluster of small metal particles 601 sticking together as shown in FIG. 6. The small metal particles 601 is generally referred to as primary particles. FIG. 7 also shows a picture of one example of an agglomerated metal powder taken by Scanning Electron Microscope (SEM).

Particle diameter 605 of the agglomerated metal powder 600 defined as D50 is 3 to 12 μm, 4.5 to 10.5 μm in another embodiment, and 6 to 9.5 μm in another embodiment. The particle diameter (D50) can be measured by laser diffraction scattering method with Microtrac model S-3500.

Particle diameter 603 of the primary particle 601 defined as D50 is 10 to 500 nm in an embodiment, 50 to 350 nm in another embodiment, 75 to 200 nm in another embodiment. The particle diameter (D50) of the primary particle can be obtained by measuring with SEM where two hundred particles are randomly selected to visually measure the particle diameter and determine the median size (D50).

Specific surface area (SA) of the agglomerated metal powder is 3.1 to 8.0 m²/g in an embodiment, 3.3 to 6.9 m²/g in another embodiment and 3.5 to 5.5 m²/g in another embodiment. The specific surface area can be measured by BET method with Monosorb™ from Quantachrome Instruments Corporation.

Tap density of the agglomerated metal powder is 0.5 to 2.5 g/cm³ in an embodiment, 0.7 to 2 g/cm³ in another embodiment, 0.9 to 1.5 g/cm³ in another embodiment. The tap density can be measured by a standard test method ASTM B527-81.

The metal of the agglomerated metal powder can be selected from the group consisting of gold, silver, platinum, palladium, an alloy thereof and a mixture thereof in an embodiment. The metal can be silver in another embodiment.

The conductive powder is 40 to 80 wt. % in an embodiment, 52 to 75 wt. % in another embodiment, 54 to 70 wt. % in another embodiment, 55 to 63 wt. % in another embodiment based on the weight of the conductive paste.

The conductive powder further comprises an additional metal powder in an embodiment. The additional metal powder can be nodular shape in an embodiment. Nodular powder is irregularly shaped powdered metal particles.

Particle diameter (D50) of the additional metal powder is 0.8 to 3 μm in an embodiment, 1.0 to 2.5 μm in another embodiment, and 1.3 to 2.1 μm in another embodiment. The particle diameter (D50) can be measured by laser diffraction scattering method with Microtrac model S-3500.

Specific surface area (SA) of the additional metal powder is 1.5 to 5.0 m²/g in an embodiment, 1.9 to 4.2 m²/g in another embodiment and 2.2 to 3.5 m²/g in another embodiment. The specific surface area can be measured by BET method with Monosorb™ from Quantachrome Instruments Corporation.

Tap density of the additional metal powder is 0.3 to 2.5 g/cm³ in an embodiment, 0.5 to 1.8 g/cm³ in another embodiment, 0.7 to 1.0 g/cm³ in another embodiment. The tap density can be measured by a standard test method ASTM B527-81.

Weight ratio of the agglomerated metal powder and the additional metal powder (agglomerated metal powder: additional metal powder) is 1:0.1 to 1:5 in an embodiment, 1:0.5 to 1:3.5 in another embodiment, 1:0.8 to 1:2 in another embodiment.

The additional metal powder is at least 10 weight percent (wt. %) in an embodiment, at least 25 wt. % in another embodiment, at least 35 wt. % in another embodiment, at least 40 wt. % in another embodiment based on the weight of the conductive powder. The additional metal powder is 80 wt. % or lower in an embodiment, 78 wt. % or lower in another embodiment, 60 wt. % or lower in another embodiment based on the weight of the conductive powder.

The conductive powder contains no additional metal powder in an embodiment. The agglomerated metal powder is 100 wt. % based on the weight of the conductive powder in an embodiment.

### (ii) Glass Frit

The glass frit functions to increase adhesion of the front electrodes to the substrate.

The chemical composition of the glass frit is not limited. The glass frit comprises a metal oxide selected from the group consisting of bismuth oxide (Bi₂O₃), boron oxide (B₂O₃), zinc oxide (ZnO), aluminum oxide (Al₂O₃), silicon oxide (SiO₂) and a mixture thereof in an embodiment. The glass frit is a Si—B—Zn glass, a Bi—B—Zn glass or a mixture thereof in another embodiment. The glass frit comprises no lead in another embodiment.

The softening point of the glass frit is 350 to 750° C. in an embodiment, 400 to 700° C. in another embodiment, 500 to 700° C. in another embodiment.

The glass frit is 3 to 14 wt. % in an embodiment, 5 to 12 wt. % in another embodiment, 6 to 10 wt. % in an embodiment based on the weight of the conductive paste.

(iii) Organic Vehicle

The conductive powder and the glass frit are dispersed in an organic vehicle to form a “paste” having suitable viscosity for applying on a substrate.

The organic vehicle comprises an organic polymer and optionally a solvent in an embodiment. A wide variety of inert viscous materials can be used as an organic polymer. The organic polymer can be selected from the group consisting of ethyl cellulose, ethylhydroxyethyl cellulose, wood rosin, phenolic resin, polymethacrylate of lower alcohol, monobutyl ether of ethylene glycol monoacetate and a mixture thereof.

The organic vehicle optionally comprises a solvent for the purpose of adjusting the viscosity in an embodiment. The solvent can be selected from the group consisting of texanol, ester alcohol, terpineol, kerosene, dibutylphthalate, butyl carbitol, butyl carbitol acetate, hexylene glycol, dibasic ester and a mixture thereof. The solvent is chosen in view of the organic polymer solubility. In an embodiment, the organic medium can be a mixture of ethyl cellulose and texanol.

The organic vehicle optionally comprises an organic additive. The organic additive comprises one or more of a thickener, stabilizer, viscosity modifier, surfactant and thixotropic agent in an embodiment. The amount of the organic additive depends on the desired characteristics of the resulting electrically conductive paste.

The organic vehicle is 10 to 69 wt. % in an embodiment, 15 to 51 wt. % in another embodiment, and 20 to 37 wt. % in another embodiment based on the total weight of the conductive paste.

### (iv) Metal Oxide

The conductive paste could further comprise a metal oxide in an embodiment. The metal oxide could reduce the damage of solder leaching. The metal oxide can be an oxide of a metal selected from the group consisting of zinc (Zn), magnesium (Mg), tin (Sn), iridium (Ir), titanium (Ti), rhodium (Rh), ruthenium (Ru), rhenium (Re) alloy thereof and mixture thereof in an embodiment. The metal oxide can be an oxide of a metal selected from the group consisting of zinc (Zn), magnesium (Mg), ruthenium (Ru), alloy thereof and mixture thereof in another embodiment.

The metal oxide can be selected from the group consisting of Ir₂O₃, IrO₂, TiO₂, Rh₂O₃, RhO₂, RhO₃, RuO₂, RuO₃, RuO₄, Re₂O₃, ReO₃, Re₂O₇, SnO, SnO₂, Pb₂Ir₂O₇, Bi₂Ir₂O₇, Lu₂Ir₂O₇, Pb₂Rh₂O₇, Bi₂Rh₂O₇, PB₂Ru₂O₇, Bi₂Ru₂O₇, and a mixture thereof in another embodiment.

The particle diameter (D₅₀) of the metal oxide is 0.1 to 10 μm in an embodiment, 0.5 to 5 μm in another embodiment.

The metal oxide is 0.5 to 10 wt % in an embodiment, 1.0 to 7 wt % in another embodiment, 1.5 to 5 wt % in another embodiment based on the weight of the conductive paste.

### EXAMPLES

The present invention is illustrated by, but is not limited to, the following examples.

Silver powder were prepared as shown in Table 1.

TABLE 1

| | | Particle | | |
|---|---|---|---|---|
| | | diameter | Surface | Tap density |
| | | D50 (μm) | area (m²/g) | (g/cm³) |
| Ag powder (A) | Spherical | 0.3 | 2.1 | 3.8 |
| Ag powder (B) | Nodular | 0.6 | 2.2 | 4.0 |
| Ag powder (C) | Flaky | 1.3 | 1.8 | 3.0 |
| Ag powder (D) | Nodular | 1.8 | 2.9 | 0.8 |
| Ag powder (E) | Agglomerated | 8.8 | 4.0 | 1.1 |

One of the silver powders, a Si—B—Zn glass frit and a metal oxide powder were dispersed in an organic vehicle in a mixer and homogenized by a three-roll mill until the metal powder was dispersed well. The amount of each materials is shown in Table 2. The organic vehicle was a mixture of 35 wt. % of a resin, 54 wt. % of a solvent and 11 wt. % of organic additives based on the weight of the organic vehicle. The paste viscosity was about 340 Pa·s measured by Brookfield HBT with a spindle #14 at 10 rpm.

An alumina substrate (25 mm long, 25 mm wide, 0.6 mm thick) having vertical slits (25 μm wide and 20 μm deep) and horizontal slits (25 μm wide and 20 μm deep) was prepared. The conductive paste was screen printed on the alumina substrate in a line pattern (500 μm wide, 16 mm long, 11 μm thick) crossing over the horizontal slit between the vertical slits. The line pattern was dried at 150° C. for 10 minutes followed by firing at 850° C. for 10 minutes.

Line spread was measured as the difference between the line pattern width 809 at the horizontal slit 803 and the original line pattern width 807 (500 μm) as shown in FIG. 8.

The result was shown in Table 2. The applied conductive paste spread out at the slit by 22 μm or more in Comparative Example (Com. Ex.) 1 to 4 where the silver powders(A) to (D) were used respectively. The line spread was 8 μm in Example (Ex.) 1 where the silver powder was (E).

TABLE 2
(wt. %)

| | Com. | Com. | Com. | Com. | |
|---|---|---|---|---|---|
| | Ex. 1 | Ex. 2 | Ex. 3 | Ex. 4 | Ex. 1 |
| Ag powder (A) | 60 | 0 | 0 | 0 | 0 |
| Ag powder (B) | 0 | 60 | 0 | 0 | 0 |
| Ag powder (C) | 0 | 0 | 60 | 0 | 0 |
| Ag powder (D) | 0 | 0 | 0 | 60 | 0 |
| Ag powder (E) | 0 | 0 | 0 | 0 | 60 |
| Glass frit | 7 | 7 | 7 | 7 | 7 |
| Organic vehicle | 30 | 30 | 30 | 30 | 30 |
| Metal oxide | 3 | 3 | 3 | 3 | 3 |
| Line spread (μm) | 52 | 40 | 22 | 25 | 8 |

Next, a mixture of the silver powder was examined. A conductive paste was prepared in the same manner as Example 1 except for using the silver powder (D) and (E) mixed together as shown in Table 3. The conductive paste was screen printed on the alumina substrate and the line width was measured in the same manner as Example 1. The line spread was 8 and 10 in Example 2 and 3 respectively.

TABLE 3
(wt. %)

| | Ex. 2 | Ex. 3 |
|---|---|---|
| Additional Ag powder (D) | 30 | 45 |
| Agglomerated Ag powder (E) | 30 | 15 |
| Glass frit | 7 | 7 |
| Organic vehicle | 30 | 30 |
| Metal oxide | 3 | 3 |
| Line spread (μm) | 8 | 10 |

What is claimed is:

1. A method of manufacturing a chip resistor comprising steps of:
preparing an insulating substrate squarely segmented with vertical slits and horizontal slits;
applying on the insulating substrate a conductive paste in a square pattern crossing over the horizontal slits;
firing the conductive paste to form front electrodes;
applying a resistor paste on the insulating substrate to bridge the front electrodes;
firing the resistor paste to form resistor layers;
forming trimming grooves on the resistor layers to adjust resistivity of the resistor layers; and
splitting the insulating substrate at the vertical slits and the horizontal slits to form chip resistors;
wherein the conductive paste comprises (i) a conductive powder comprising an agglomerated metal powder, wherein particle diameter (D50) of the agglomerated metal powder is 3 to 12 μm and specific surface area (SA) of the agglomerated metal powder is 3.1 to 8.0 m²/g, (ii) a glass frit and (iii) an organic vehicle.

2. The method of claim 1, wherein the insulating substrate is a ceramic substrate.

3. The method of claim 1, wherein the thickness of the insulating substrate is 0.1 to 2 mm.

4. The method of claim 1, wherein the firing peak temperature is 700 to 950° C. in the step of firing the conductive paste.

5. The method of claim 1, wherein the firing peak temperature is 700 to 950° C. in the step of firing the resistor paste.

6. The method of claim 1, wherein the trimming grooves are formed by laser.

7. The method of claim 1, wherein tap density of the agglomerated metal powder is 0.5 to 2.5 g/cm³.

8. The method of claim 1, wherein the metal of the agglomerated metal powder can be selected from the group consisting of gold, silver, platinum, palladium, an alloy thereof and a mixture thereof.

9. The method of claim 1, wherein the conductive powder further comprises an additional metal powder, wherein particle diameter (D50) of the additional metal powder is 0.8 to 3 μm and specific surface area (SA) of the additional metal powder is 1.5 to 5.0 m²/g.

10. The method of claim 1, wherein the conductive powder is 40 to 80 weight percent (wt. %), the glass frit is 3 to 14 wt % and the organic vehicle is 10 to 69 wt. %, wherein the wt. % is based on the weight of the conductive paste.

11. A conductive paste comprising (i) a conductive powder comprising an agglomerated metal powder, wherein particle diameter (D50) of the agglomerated metal powder is 3 to 12 μm and specific surface area (SA) of the agglomerated metal powder is 3.1 to 8.0 m²/g, (ii) a glass frit and (iii) an organic vehicle.

12. The conductive paste of claim 11, wherein tap density of the agglomerated metal powder is 0.5 to 2.5 g/cm³.

13. The conductive paste of claim 11, wherein the metal of the agglomerated metal powder can be selected from the group consisting of gold, silver, platinum, palladium, an alloy thereof and a mixture thereof.

14. The conductive paste of claim 11, wherein the conductive powder further comprises an additional metal powder, wherein particle diameter (D50) of the additional metal powder is 0.8 to 3 μm and specific surface area (SA) of the additional metal powder is 1.5 to 5.0 m²/g.

15. The conductive paste of claim 12, wherein the conductive powder is 40 to 80 weight percent (wt. %), the glass frit is 3 to 14 wt. % and the organic vehicle is 10 to 69 wt. %, wherein the wt. % is based on the weight of the conductive paste.
